(19) United States
(12) Patent Application Publication
(10) Pub. No.: US 2021/0337855 A1
(43) Pub. Date: Nov. 4, 2021

(54) METHOD FOR FIXING SOLID PARTICLES TO DRY FOOD SHEET

(71) Applicant: STANDARD FOODS CORPORATION, Taipei (TW)

(72) Inventors: Chao-Bin Chen, Taoyuan City (TW); Hsiao-Chuan Peng, Taoyuan City (TW)

(21) Appl. No.: 17/023,387

(22) Filed: Sep. 17, 2020

(30) Foreign Application Priority Data
Apr. 30, 2020 (TW) 109114612

(51) Int. Cl. A23P 10/25; A23L 7/126; A23L 11/00; A23L 25/00

(52) U.S. Cl. CPC A23P 10/25; A23L 7/126; A23V 2002/00; A23L 25/20; A23L 11/01

(57) ABSTRACT

A method for fixing solid particles to a dry food sheet includes the following steps. Two rollers are provided, and a distance between the two rollers is maintained from 6 mm to 30 mm. The two rollers are heated to a range from 120° C. to 180° C. Solid particles and a food slurry with a viscosity from 25,000 cp to 100,000 cp are mixed to form a food mixture and poured over the two rollers. The two rollers are rotated to pass the food mixture through the two rollers. After the food mixture adhered to the two rollers are heated for a drying time period from 100 seconds to 600 seconds, the dried food mixture is scraped off from the two rollers.

### CROSS-REFERENCE TO RELATED APPLICATION

This application claims priority to Taiwan Application Serial Number 109114612, filed Apr. 30, 2020 which is herein incorporated by reference in its entirety.

### BACKGROUND

### Field of Invention

The present disclosure relates to a food manufacturing method, and more particularly, to a dry food manufacturing method.

### Description of Related Art

Adding solid particles to dry food is configured to preserve the nutrients in the particles completely. In order to preserve food easily, some food processing methods choose to grind particles for easy processing and quality control. How to provide a manufacturing method that adds solid particles to dry food while maintaining food safety is a direction food suppliers are striving for.

### SUMMARY

In one or more embodiments, a method for fixing solid particles to a dry food sheet includes the following steps. Two rollers are provided, and a distance between the two rollers is maintained from 6 mm to 30 mm. The two rollers are heated to a range from 120° C. to 180° C. Solid particles and a food slurry with a viscosity from 25,000 cp to 100,000 cp are mixed to form a food mixture and poured over the two rollers. The two rollers are rotated to pass the food mixture through the two rollers. After the food mixture adhered to the two rollers is heated for a drying time period from 100 seconds to 600 seconds, the dried food mixture is scraped off from the two rollers.

In one or more embodiments, the temperature of the two rollers ranges from 145° C. to 180° C., and the drying time period ranges from 100 seconds to 250 seconds when the viscosity of the food slurry ranges from 25,000 cp to 32,000 cp.

In one or more embodiments, the distance between the two rollers ranges from 6 mm to 12 mm.

In one or more embodiments, the temperature of the two rollers ranges from 130° C. to 160° C., and the drying time period ranges from 200 seconds to 480 seconds when the viscosity of the food slurry ranges from 30,000 cp to 52,000 cp.

In one or more embodiments, the distance between the two rollers ranges from 10 mm to 20 mm.

In one or more embodiments, the temperature of the two rollers ranges from 125° C. to 155° C., and the drying time period ranges from 350 seconds to 500 seconds when the viscosity of the food slurry ranges from 50,000 cp to 70,000 cp.

In one or more embodiments, the distance between the two rollers ranges from 11 mm to 25 mm.

In one or more embodiments, the temperature of the two rollers ranges from 120° C. to 150° C., and the drying time period ranges from 400 seconds to 600 seconds when the viscosity of the food slurry ranges from 65,000 cp to 100,000 cp.

In one or more embodiments, the distance between the two rollers ranges from 20 mm to 30 mm.

In one or more embodiments, the solid particles include nut seeds, cereal grains, legume seeds or other granular foods.

In sum, the method for manufacturing the dry sheet food disclosed herein provides an appropriate processing range such that a sheet food containing complete solid particles can be manufactured, and the dry sheet food and its solid particles can be properly dried, sterilized and easily stored, thereby providing consumers with richer nutrition and better food safety.

It is to be understood that both the foregoing general description and the following detailed description are by examples, and are intended to provide further explanation of the invention as claimed.

### BRIEF DESCRIPTION OF THE DRAWINGS

The invention can be more fully understood by reading the following detailed description of the embodiment, with reference made to the accompanying drawings as follows:

FIG. 1 illustrates a flow chart of a method for fixing solid particles to a dry food sheet according to one embodiment of the present disclosure; and

FIG. 2 illustrates a side view of an equipment for performing a method for fixing solid particles to a dry food sheet according to one embodiment of the present disclosure.

### DETAILED DESCRIPTION

Reference will now be made in detail to the present embodiments of the invention, examples of which are illustrated in the accompanying drawings. Wherever possible, the same reference numbers are used in the drawings and the description to refer to the same or like parts.

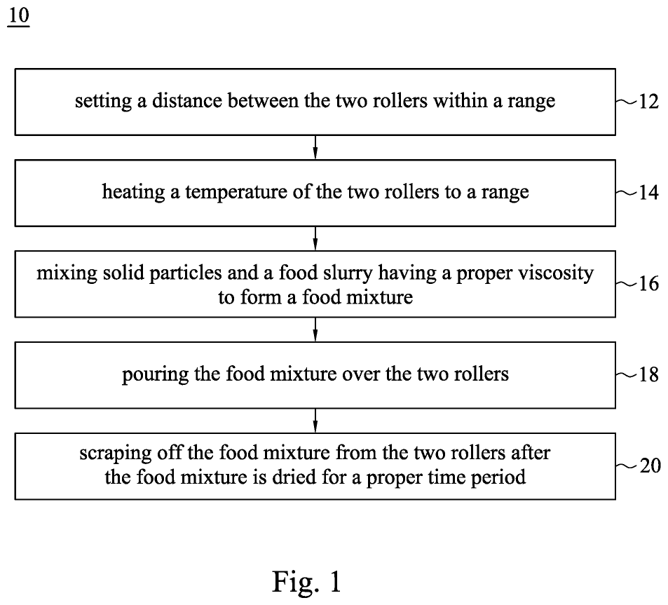

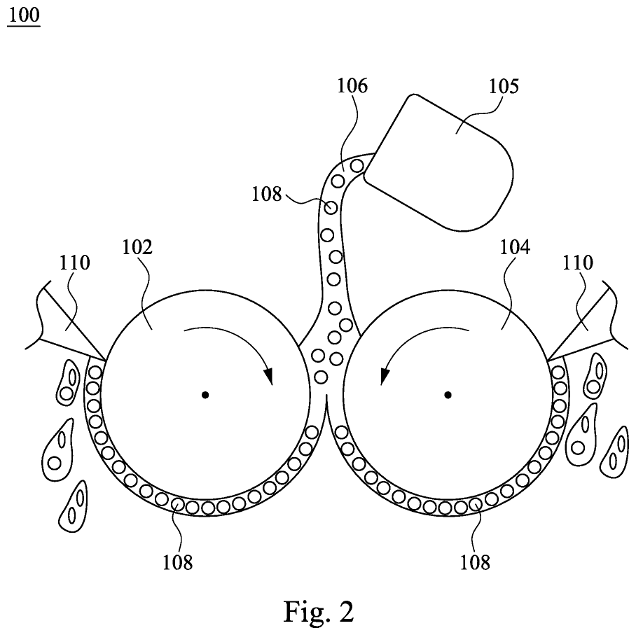

Reference is made to FIGS. 1 and 2. FIG. 1 illustrates a flow chart of a method 10 for fixing solid particles to a dry food sheet according to one embodiment of the present disclosure; and FIG. 2 illustrates a side view of an equipment 100 for performing a method for fixing solid particles to a dry food sheet according to one embodiment of the present disclosure.

The method 10 for fixing solid particles on a dry food sheet of the present invention is performed by the equipment 100. The equipment 100 includes two rollers (102, 104), a pouring device 105, and a scraper 110. The pouring device 105 is used to inject a food mixture of solid particles 108 and a food slurry 106 on the two rollers (102, 104). The scraper 110 is used to scrape off the sheets (the dried food slurry 106) with the solid particles 108 adhered on a surface of the two rollers (102, 104). The device 100 shown in FIG. 2 is only an example. The size of the two rollers can be inconsistent (for example, a large roller matches a small roller); the two rollers are not limited to be arranged side by side (for example, the small roller may be located above the large roller); The rolling direction is also not limited to the direction illustrated in the figure (for example, the two rollers respectively roll in directions opposite to the directions in the figure).

The above-mentioned solid particles may include nut seeds (e.g., almonds, cashews, walnuts, walnuts, pine nuts, pistachios, macadamia beans, sunflower seeds, pumpkin seeds, melon seeds, black sesame seeds, white sesame seeds, peanuts), cereal grains (e.g., brown rice, purple rice, white rice, wheat, barley, oats, buckwheat, quinoa, corn, coix seed, millet, sweet potato, potato, taro, pumpkin, yam, lotus root), legume seeds (e.g. red beans, mung beans, Black beans, pinto beans, broad beans, emperor beans) and other granular foods (e.g., chestnuts, lotus seeds, chia seeds), but not being limited to thereto.

In step 12, a distance between the two rollers (102, 104) is set to a predetermined range. The distance between the two rollers is used to control a thickness of the dried food slurry 106, and is also associated with the size of the food particles to be fixed. Thicker sheets are able to fix food particles of matching sizes, so that the food particles can be heated together on the roller without peeling off in advance. The distance between the two rollers is preferably greater than the size of the food particles, and the food particles are less likely to be crushed or a completeness of the food particles can be better maintained, but not being limited to thereto. In addition, the distance between the two rollers will also affect a drying time period required for the food slurry 106 to be dried into sheets on the roller.

In step 14, the two rollers are rotated (for example, rotate along the arrows in FIG. 2) and a temperature of the two rollers (102, 104) is heated up to a predetermined range. The two rollers are used to provide enough heat to dry and sterilize the food slurry and food particles.

In steps 16 and 18, a plurality of solid particles 108 are mixed with a food slurry 106 of an appropriate viscosity range first, and then injected over the two rollers (102, 104) by the pouring device 105. At this time, the two rotating rollers (102, 104) pass the food slurry 106 and the food particles 108 through a gap between the two rollers (102, 104) to control the thickness of the dried food sheets.

In step 20, when the food mixture of food slurry 106 and solid particles 108 adheres to the two rollers (102, 104) for a proper drying time, the scraper 110 can be used to scrape the dried sheets of the food mixture off the surface of the two rollers (102, 104). In practice, by controlling the rotation speed of the two rollers (102, 104), the drying time period from the contact of the food slurry 106 to the surface of the roller to the position of the scraper 110 is controlled.

In order to firmly adhere the solid particles 108 to the food slurry 106, a viscosity of the food slurry 106 needs to match with the distance between the two rollers, the temperature of the rollers, and the drying time period to produce dried and sterilized dry sheet food. Embodiments that can meet this requirement are listed below.

In the first embodiment, the viscosity of the food slurry 106 is controlled to a range from 50,000 cp to 70,000 cp, which needs to be matched with a distance between two rollers ranging from 11 mm to 25 mm, a roller heating temperature ranging from 125° C. to 155° C. or less, and a drying time period ranging from 350 seconds to 530 seconds.

The formula of the food slurry 106 in this embodiment may include 51 wt % of wheat flour, 6 wt % of sugar, and 39 wt % of water to obtain a food slurry with a viscosity of 63,400 cp, and 4 wt % of chia seed solid particles are added. Users may slightly adjust the percentage of water to obtain a viscosity range of 50,000 cp to 70,000 cp, which can match with the above-mentioned appropriate range of the distance between the two rollers, the roller heating temperature and the roller drying time period.

When the implementation of the method 10 exceeds the above-mentioned appropriate range, it may produce unqualified dry sheet food. For example, when the distance between the rollers is less than 11 mm, the heating temperature of the roller is higher than 155° C. and the drying time period exceeds 530 seconds, it is easy to produce burnt dry sheet food. When the distance between the rollers is greater than 25 mm, the heating temperature of the roller is lower than 125° C., and the drying time period is less than 350 seconds, it is easy to produce sheet foods with incomplete drying, incomplete sterilization, and shortened shelf life.

In the second embodiment, the viscosity of the food slurry 106 is controlled to a range from 30,000 cp to 52,000 cp, which needs to be matched with a distance between the two rollers ranging from 10 mm to 20 mm, a roller heating temperature ranging from 130° C. to 160° C., and a drying time period ranging from 200 seconds to 480 seconds.

The formula of the food slurry 106 in this embodiment may include 23 wt % barley flour, 4 wt % oat flour, 12 wt % sugar, and 55 wt % water to obtain a food slurry with a viscosity of 50,000 cp, and 6 wt % of sesame solid particles are added. Users may slightly adjust the proportion of water to obtain a viscosity range of 30,000 cp to 52,000 cp, which can match with the above-mentioned appropriate range of the distance between the two rollers, the roller heating temperature and the roller drying time period.

When the implementation of the method 10 exceeds the above-mentioned appropriate range, it may produce unqualified dry sheet food. For example, when the distance between the rollers is less than 10 mm and the heating temperature of the roller is higher than 160° C. and the drying time period exceeds 480 seconds, it is easy to produce burnt dry sheet food. When the distance between the rollers is greater than 20 mm, the heating temperature of the roller is lower than 130° C. and the drying time period is less than 200 seconds, it is easy to produce sheet food with incomplete drying, incomplete sterilization, and shortened shelf life.

In the third embodiment, the viscosity of the food slurry 106 is controlled to a range from 25,000 cp to 32,000 cp, which needs to be matched with the distance between the two rollers from 6 mm to 12 mm, the roller heating temperature from 145° C. to 180° C. and a drying time period ranging from 100 seconds to 250 seconds.

The formula of the food slurry 106 of this embodiment may include 36 wt % of flour, 5 wt % of oat flour, 9 wt % of sugar, and 47 wt % of water to obtain a food slurry with a viscosity of 27,000 cp, and 3 wt % of sesame solid particles are added. Users may slightly adjust the proportion of water to obtain a viscosity range of 25,000 cp to 32,000 cp, which can match with the above-mentioned appropriate range of the distance between the two rollers, the roller heating temperature and the roller drying time period.

When the implementation of the method 10 exceeds the above-mentioned appropriate range, it may produce unqualified dry sheet food. For example, when the distance between the rollers is less than 6 mm, the heating temperature of the roller is higher than 180° C. and the drying time exceeds 250 seconds, it is easy to produce burnt dry sheet food. When the distance between the rollers is greater than 12 mm, the heating temperature of the roller is lower than 145° C. and the drying time period is less than 100 seconds, it is easy to produce sheet foods with incomplete drying, incomplete sterilization, and shortened shelf life.

In the fourth embodiment, the viscosity of the food slurry 106 is controlled to a range from 65,000 cp to 100,000 cp, which needs to be matched with the distance between the two rollers from 20 mm to 30 mm, the roller heating temperature ranging from 120° C. to 150° C., and a drying time period ranging from 400 seconds to 600 seconds.

The formula of the food slurry 106 in this embodiment may include 37 wt % of wheat flour, 11 wt % of oat flour, 4 wt % of rice flour, 6 wt % of sugar, and 37 wt % of water to obtain a food slurry with a viscosity of 90,000 cp, and 5 wt % of sesame solids are added. Users may slightly adjust the proportion of water to obtain a viscosity range of 65,000 cp to 100,000 cp, which can match with the above-mentioned appropriate range of the distance between the two rollers, the roller heating temperature, and the roller drying time period.

When the implementation of method 10 exceeds the above-mentioned appropriate range, it may produce unqualified dry sheet food. For example, when the distance between the rollers is less than 20 mm, the heating temperature of the roller is higher than 150° C. and the drying time period exceeds 600 seconds, it is easy to produce burnt dry sheet food. When the distance between the rollers is greater than 30 mm, the heating temperature of the roller is lower than 120° C. and the drying time period is less than 400 seconds, it is easy to produce sheet food with incomplete drying, incomplete sterilization, and shortened shelf life.

In summary, the method for manufacturing the dry sheet food disclosed herein provides an appropriate processing range such that a sheet food containing complete solid particles can be manufactured, and the dry sheet food and its solid particles can be properly dried, sterilized and easily stored, thereby providing consumers with richer nutrition and better food safety.

Although the present invention has been described in considerable detail with reference to certain embodiments thereof, other embodiments are possible. Therefore, the spirit and scope of the appended claims should not be limited to the description of the embodiments contained herein.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims.

What is claimed is:

1. A method for fixing solid particles to a dry food sheet comprising:
providing two rollers, and maintain a distance between the two rollers in a range from 6 mm to 30 mm;
heating a temperature of the two rollers to a range from 120° C. to 180° C.;
mixing a plurality of solid particles and a food slurry having a viscosity ranging from 25,000 cp to 100,000 cp to form a food mixture, and pouring the food mixture over the two rollers;
rotating the two rollers so that the food mixture is passed between the two rollers; and
scraping off the food mixture from the two rollers after the food mixture adhered to the two rollers is heated for a drying time period ranging from 100 seconds to 600 seconds.

2. The method of claim 1, wherein the temperature of the two rollers ranges from 145° C. to 180° C., and the drying time period ranges from 100 seconds to 250 seconds when the viscosity of the food slurry ranges from 25,000 cp to 32,000 cp.

3. The method of claim 2, wherein the distance between the two rollers ranges from 6 mm to 12 mm.

4. The method of claim 1, wherein the temperature of the two rollers ranges from 130° C. to 160° C., and the drying time period ranges from 200 seconds to 480 seconds when the viscosity of the food slurry ranges from 30,000 cp to 52,000 cp.

5. The method of claim 4, wherein the distance between the two rollers ranges from 10 mm to 20 mm.

6. The method of claim 1, wherein the temperature of the two rollers ranges from 125° C. to 155° C., and the drying time period ranges from 350 seconds to 500 seconds when the viscosity of the food slurry ranges from 50,000 cp to 70,000 cp.

7. The method of claim 6, wherein the distance between the two rollers ranges from 11 mm to 25 mm.

8. The method of claim 1, wherein the temperature of the two rollers ranges from 120° C. to 150° C., and the drying time period ranges from 400 seconds to 600 seconds when the viscosity of the food slurry ranges from 65,000 cp to 100,000 cp.

9. The method of claim 8, wherein the distance between the two rollers ranges from 20 mm to 30 mm.

10. The method of claim 1, wherein the solid particles include nut seeds, cereal grains, legume seeds or other granular foods.
